(19) United States
(12) Patent Application Publication
(10) Pub. No.: US 2010/0018944 A1
(43) Pub. Date: Jan. 28, 2010

(54) PATTERNING METHOD

(75) Inventors: Yu-Tsung Lai, Tainan County (TW); Shih-Chang Chang, Tainan County (TW); Chieh-Ju Wang, Tainan City (TW); Jyh-Cherng Yau, Tainan City (TW); Jiunn-Hsiung Liao, Tainan County (TW)

Correspondence Address: NORTH AMERICA INTELLECTUAL PROPERTY CORPORATION, P.O. BOX 506, MERRIFIELD, VA, 22116, US

(73) Assignee: United Microelectronics Corp., Hsinchu (TW)

(21) Appl. No.: 12/179,879

(22) Filed: Jul. 25, 2008

(51) Int. Cl. H01B 13/00

(52) U.S. Cl. 216/13

(57) ABSTRACT

A patterning method is provided. A patterned photoresist layer is formed on a bottom anti-reflective coating (BARC), having therein an opening exposing a portion of the BARC. The patterned photoresist layer is treated with a first plasma-generating gas including a fluorocarbon species to form a polymer layer on the surface of the PR layer and the sidewall of the opening. The patterned photoresist layer is used as a mask to etch the BARC with a second plasma-generating gas, which includes Ar and H₂ but no fluorocarbon species or oxygen-containing species, to remove the exposed portion of the BARC.

### BACKGROUND OF THE INVENTION

1. Field of Invention

This invention relates to an integrated circuit (IC) fabricating process, and more particularly to a patterning method for films formed in an IC fabricating process.

2. Description of Related Art

Film patterning is an important issue in an IC process. A patterning procedure includes a lithography process for forming photoresist patterns on the target film and an etching process that removes the exposed film with the photoresist patterns as a mask.

Most patterning methods use photoresist (PR) materials as etching masks, while a PR material is easily etched in dry etching. Hence, the thickness of a PR layer often has to be increased as required by the etching process so that the PR layer is not etched through in the etching and the portions of the target film to be kept are not damaged.

On the other hand, with the advance in IC design and reduction in linewidth, the lithographic resolution has to be raised increasingly. Since the depth of focus (DOF) of lithography decrease with an increase in the resolution, the profile of the PR pattern is degraded. Moreover, when the light beam for exposure is projected on the PR layer, it is refracted at its interface and thus subjected to broadening, which is a problem as the linewidth is small. Further, when the linewidth is small, the aspect ratio of PR pattern is increased and the PR layer peels off more easily causing pattern error or even wafer waste. The above three problems can be improved by decreasing the PR thickness.

In addition, a bottom anti-reflection coating (BARC) usually made of an organic substance can be formed prior to the photoresist layer to avoid reflection of the exposure light passing the PR layer that would cause interference and change the predetermined exposure intensity. However, an extra BARC etching step has to be added accordingly. Since the etching selectivity of the BARC to the PR layer is not high, the PR thickness has to be increased to compensate the consumption in the etching. This increases the cost and adversely affects the process resolution.

Moreover, some PR materials have lower anti-etching resistance so that the edge of an opening pattern is damaged irregularly. Therefore, the pattern of the target film transferred therefrom has a striation issue at its edge or surface, or even has a deformed profile, such as an irregular edge of a via/contact hole, a larger critical dimension (CD) at an upper portion of an opening or a non-vertical sidewall. Moreover, because the edges of PR patterns are eroded more easily, the PR-masked areas are shrunk changing the CD, for example, reducing a metal line width or increasing a via hole width, or even causing a short between two neighboring contacts. Consequently, the device design, process control and device performance are all affected, especially when the process linewidth is reduced.

In addition to development of highly resistant PR materials, process modification is also useful in solving the above PR-caused problems. For example, a new etching recipe can be designed to increase the etching selectivity of the BARC to the PR, or a pre-etching treatment can be done to the post-development PR patterns. Moreover, some advanced approaches, such as the tri-layer approach, replace the conventional PR-BARC structure with a multi-layer structure and conduct multiple etching steps in different selectivities to reduce the affect of the etching to the pattern transfer. Though the approaches have good effects in pattern transfer accuracy, they are higher in the cost.

### SUMMARY OF THE INVENTION

Accordingly, this invention provides a patterning method, which can reduce the photoresist loss and the striation issue caused by etching.

The patterning method of this invention is described as follows. A patterned photoresist layer is formed on a bottom anti-reflection coating (BARC), having therein an opening pattern exposing a portion of the BARC. A first plasma-generating gas containing fluorocarbon species is used to treat the patterned photoresist layer and form a polymer layer on the patterned photoresist layer and on the sidewall of the opening. A second plasma-generating gas is then used to etch the exposed portion of the BARC with the patterned photoresist layer as a mask, so as to form a patterned BARC, wherein the second plasma-generating gas contains Ar and H₂ but no fluorocarbon species or oxygen-containing species.

In an embodiment, the fluorocarbon compound is selected from CₐF_{b} and CₓH_{y}F_{z}, wherein a ranges from 1 to 4, b ranges from 4 to 8, x is equal to 1, y ranges from 1 to 3, and z ranges from 1 to 3.

In an embodiment, the fluorocarbon species includes a high F/C-ratio species and a low F/C-ratio species, wherein the F/C ratio of the high F/C-ratio species ranges from 4 to 3 and the F/C ratio of the low F/C-ratio species ranges from 2 to 1. The flow rate ratio of the high F/C-ratio species to the low F/C-ratio species may range from 20:1 to 20:3. The high F/C-ratio species may include one or more fluorocarbon compounds. In a case, the high F/C-ratio species includes CF₄ and CHF₃, the low F/C-ratio species includes C₄F₈, the flow rate ratio of CF₄ to CHF₃ ranges from 2:3 to 3:2, the flow rate ratio of CF₄ to C₄F₈ ranges from 20:1 to 20:3, and the flow rate of CF₄ is lower than 50% of the sum of the respective flow rates of the high F/C-ratio species and the low F/C-ratio species.

In an embodiment, the flow rate ratio of Ar to H₂ ranges from 2:3 to 3:2.

In an embodiment, the patterned photoresist layer is treated under a pressure of 30-300 mTorr.

In an embodiment, the patterned photoresist layer is treated with a top-electrode power of 250-1000 W.

In an embodiment, the patterned photoresist layer is treated with a bottom-electrode power of 200-800 W.

In an embodiment, the BARC is etched under a pressure of 4-40 mTorr. In an embodiment, the BARC is etched with a top-electrode power of 750-3000 W. In an embodiment, the BARC is etched with a bottom-electrode power of 250-1000 W.

In an embodiment, the BARC is formed on a material layer, and the patterning method further including etching the material layer with the patterned photoresist layer as a mask after the patterned BARC is formed. It is possible that the material layer is a dielectric layer and the opening pattern is a via hole pattern or a contact hole pattern.

A patterning method of this invention is applied to a BARC that has thereon a patterned photoresist layer that has therein an opening pattern exposing a portion of the BARC. The method includes using a plasma-generating gas to etch the exposed portion of the BARC with the photoresist layer as a mask, where the plasma-generating gas contains Ar and H₂ but no fluorocarbon species or oxygen-containing species.

In an embodiment, the flow rate ratio of Ar to H₂ ranges from 2:3 to 3:2.

In an embodiment, the BARC is etched under a pressure of 4-40 mTorr.

In an embodiment, the BARC is etched with a top-electrode power of 750-3000 W. In an embodiment, the BARC is etched with a bottom-electrode power of 250-1000 W.

Because this invention utilizes fluorocarbon species to treat the photoresist and use Ar and H₂ to etch the BARC, the etching resistance of the photoresist layer and the etching selectivity of the BARC are raised so that the photoresist loss and striation issue are reduced.

In order to make the aforementioned and other objects, features and advantages of the present invention comprehensible, a preferred embodiment accompanied with figures is described in detail below.

### BRIEF DESCRIPTION OF THE DRAWINGS

FIGS. 1A-1D illustrate, in a cross-sectional view, a patterning process applied to IC manufacturing according to an embodiment of this invention.

FIG. 2 is a flow chart of a patterning method according to the embodiment of this invention.

FIG. 3 is an electron microscopic image of the local IC structure after the etching of the BARC in an example according to the embodiment of this invention.

### DESCRIPTION OF EMBODIMENTS

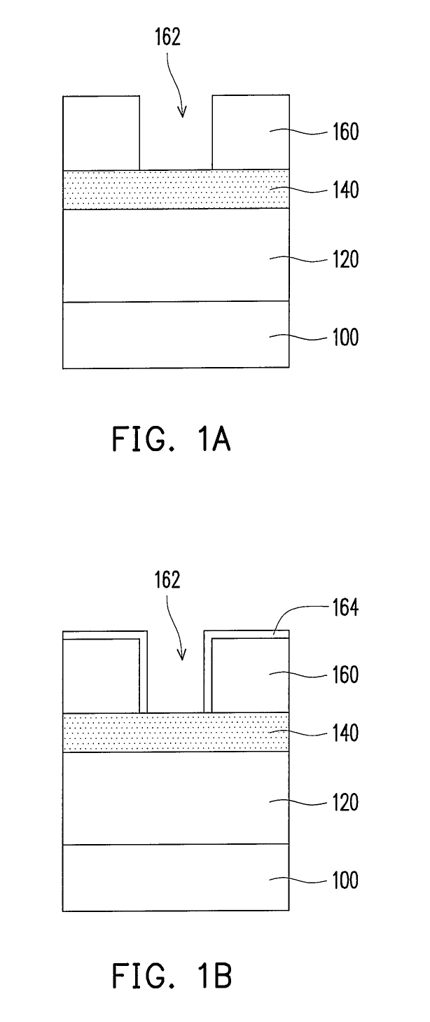

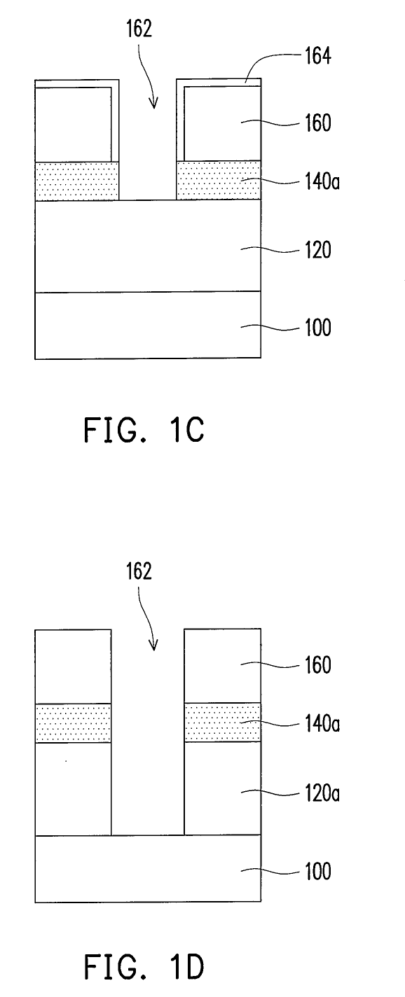

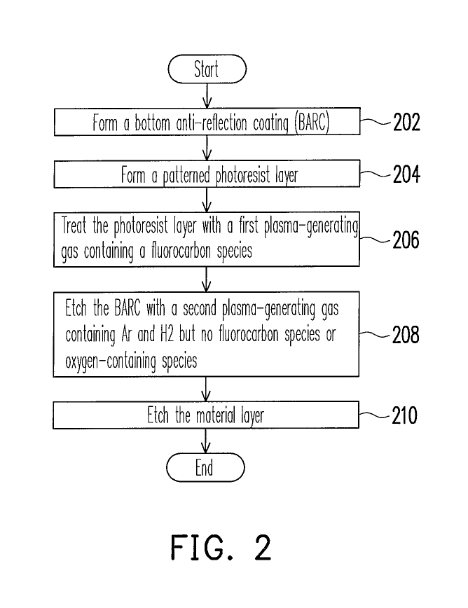

FIGS. 1A-1D illustrate, in a cross-sectional view, a patterning process applied to IC manufacturing according to the embodiment of this invention. FIG. 2 is a flow chart of a patterning method according to the embodiment of this invention.

Referring to FIGS. 1A and 2, a substrate 100 having a material layer 120 to be patterned thereon is provided. The substrate 100 includes one used or fabricated in a microelectronic process, and may include a single material or multiple layers of materials selected from conductors, semiconductors and dielectrics. In an embodiment, the substrate 100 is a silicon substrate with semiconductor devices formed thereon. In another embodiment, the substrate 100 includes an etch-stop layer (not shown), which is usually made of a material with a higher etch-resistance than the material layer 120, such as silicon nitride (SiN), to prevent other layers in the substrate 100 from being damaged in the etching of the material layer 120.

The above material layer 120 may be a conductive layer or dielectric layer. The dielectric layer may be an inter-layer dielectric (ILD) layer or an inter-metal dielectric (IMD) layer, and may include silicon oxide, SiN, SiON, phosphosilicate glass (PSG), borophosphosilicate glass (BPSG), undoped silicate glass (USG), fluorosilicate glass (FSG) or a low-k material having a dielectric constant below 4.0. The dielectric layer may be formed by atmospheric pressure CVD (APCVD), low-pressure CVD (LPCVD), plasma-enhanced CVD (PECVD) or high-density-plasma CVD (HDP-CVD).

Referring to FIGS. 1A and 2 again, a BARC 140 and a patterned PR layer 160 are sequentially formed on the material layer 120 (steps 202, 204). In an embodiment, the BARC 140 is formed with spin-coating and may include an organic material. The thickness of the BARC 140 depends on its material and the process requirements. In an example, the thickness of the BARC 140 ranges from about 20 nm to about 200 nm.

The patterned PR layer 160 has therein opening 162 exposing a portion of the BARC 140. The PR layer 160 may be formed as follows. A blanket PR layer is formed on the BARC 140 with a known method, such as spin-coating, in a suitable thickness, such as 100 nm to 1 μm. The PR layer is then exposed with a known method that may use a high-resolution exposure light like deep ultraviolet (DUV) light, and is developed to form an opening 162, which is possibly for forming a via hole or a contact hole. In an embodiment, the patterned PR layer 160 with the opening therein serves as an etching mask for forming an opening in the BARC 140. In another embodiment, the patterned PR layer 160 also serves the etching mask of the material layer 120 as a dielectric layer to form a via hole exposing a portion of the underlying metal line layer.

Referring to FIGS. 1B and 2, before the etching step of the BARC 140, a PR treatment is done to treat the patterned PR layer 160 (step 206) and form a polymer layer 164 on the patterned PR layer 160 and the sidewall of the opening 162. It is noted that in the prior art, the BARC is etched directly after the lithography process.

In another embodiment, the PR treatment is conducted after the substrate 100 is moved to another environment, which may be an etching chamber, such as a reactive ion etch (RIE) etcher or a high-density plasma (HDP) etcher. The etching chamber controls parameters, such as pressure and electrode powers, to form plasma from the gas introduced and controls the rate of polymer formation higher than that of polymer loss due to ion bombardment.

In an embodiment, the plasma-generating gas including a fluorocarbon species, which may be selected from CₐF_{b} and CₓH_{y}F_{z}, wherein a ranges from 1 to 4, b ranges from 4 to 8, x is equal to 1, y ranges from 1 to 3, and z ranges from 1 to 3. Examples of CₐF_{b} include CF₄, C₄F₆, C₄F₈ and C₅F₈, etc. Examples of CₓH_{y}F_{z} include CHF₃ and CH₂F₂, etc. More specifically, the embodiment introduces into the chamber at least two kinds of fluorocarbon species including a high fluorine/carbon (F/C) ratio species and a low F/C-ratio species. The high F/C-ratio species can make the plasma rich in fluorine and be able to etch the PR layer. The low F/C-ratio species has higher carbon content and easily causes longer carbon chains that react with the carbon-containing by-product of PR etching to form a polymer. The F/C ratio of the high F/C-ratio species ranges from 4 to 3. The F/C ratio of the low F/C-ratio species ranges from 2 to 1. In an embodiment, the high F/C-ratio species may be selected from CF₄, CHF₃ and CH₂F₂, etc., and the low F/C-ratio species may be selected from C₄F₈, C₄F₆ and C₅F₈, etc. The high F/C-ratio species is not limited to a single fluorocarbon compound, but may include two or more fluorocarbon compounds. Similarly, the low F/C-ratio species is not limited to a single fluorocarbon compound but may include two or more fluorocarbon compounds. In an embodiment, the flow rate ratio of the high F/C-ratio species to the low F/C-ratio species ranges from 20:1 to 20:3. In an embodiment, the high F/C-ratio species includes CF₄ and CHF₃, the low F/C-ratio species includes C₄F₈, the flow rate ratio of CF₄ to CHF₃ ranges from 2:3 to 3:2, the flow rate ratio of CF₄ to C₄F₈ ranges from 10:1 to 10:3, and the flow rate of CF₄ is lower than 50% of the sum of the respective flow rates of the high F/C-ratio species and the low F/C-ratio species.

In addition to the species and the flow rates of the gases, other parameters in the chamber also have to be adjusted suitably. For example, increasing the pressure can raise the number of gas particles in the plasma and the frequency of collision between the particles to shorten the mean free path thereof, so that the ion bombardment effect is reduced lowering the etching rate of the PR layer and increasing the polymer formation rate. In an embodiment, adjusting the chamber pressure over 100 mTorr facilitates the formation of the polymer layer 164.

In the PR treatment of an embodiment, CF₄, CHF₃ and C₄F₈ are introduced in flow rates of 90-110 sccm, 90-110 sccm and 9-11 sccm respectively, the pressure in the chamber is kept constant between 100-200 mTorr, the top-electrode power ranges from 400 W to 600 W, the bottom-electrode power ranges from 300 W to 500 W, and the direct current (DC) bias is adjusted to a value between −600V and −400V.

In an embodiment, the opening pattern in the PR layer is a via hole pattern, and the PR treatment causes carbon-chain polymer to form and accumulate on the surface of the patterned PR layer 160 and the sidewall of the via hole pattern 162 to reduce the CD of the via hole pattern 162. Hence, the after-etch CD can be controlled by changing the duration of the PR treatment to adjust the thickness of the polymer layer 164. Moreover, the polymer on the sidewall of the opening can resist lateral etching to inhibit the PR shrinkage.

Referring to FIGS. 1C and 2, after the PR treatment in step 206, the BARC 140 is etch-patterned using the patterned PR layer 160 with the polymer layer 164 thereon as a mask (step 208), so as to form a patterned BARC 140a. The plasma-generating gas used in the etching contain Ar and H₂ but no fluorocarbon species or oxygen-containing species, so that the exposed portion of the BARC 140 is removed but the polymer layer 164 is retained and chemically modified by the plasma.

In an embodiment, the flow rate ratio of Ar to H₂ ranges from 2:3 to 3:2. In another embodiment, the flow rate ratio of Ar to H₂ ranges from 4:1 to 4:2. In still another embodiment, the flow rate ratio of Ar to H₂ ranges from 6:1 to 6:2.

The Ar ion of high dosage is stronger in the bombardment effect and is the main factor of the anisotropic etching of the BARC 140, and H₂ is added for producing H-ion and H-atom to react with the polymer layer 164 so that some fluorine in the polymer is replaced by hydrogen and the properties of the polymer layer 164 is modified. On the other hand, because of the presence of Ar gas with strong bombardment effect, the addition of a reactive species like fluorocarbon species would greatly raise the etching rates of the PR layer 160 and the polymer layer 164 and damage the polymer layer 164 on the sidewall of the opening 162. Meanwhile, oxygen species is quite reactive to the organic PR material and easily causes PR loss. Accordingly, to protect the patterned PR layer 160 and the polymer layer 164, fluorocarbon species or oxygen-containing species is not used in the etching step of the BARC 140.

In the etching step of the BARC 140 according to an embodiment, Ar and H₂ are introduced in flow rates of 90-110 sccm and 90-110 sccm respectively, the pressure is set at 10-30 mTorr, the top-electrode power is set at 1000-2000 W and the bottom-electrode power is set at 400-600 W to produce plasma. The portion of the BARC 140 not covered by the patterned PR layer 160 is removed by the plasma to form a patterned BARC 140a as shown in FIG. 1C.

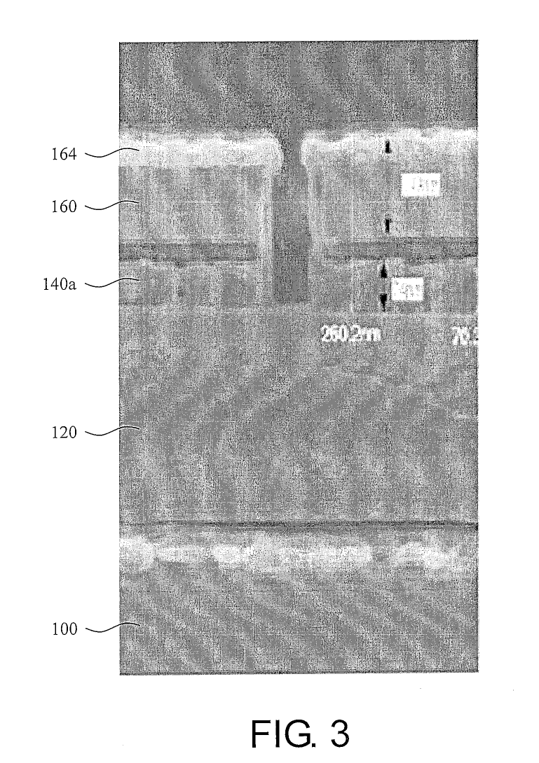

FIG. 3 is an electron microscopic image of the local IC structure after the etching of the BARC in an example according to the embodiment of this invention, while FIG. 1C is an illustration of the same local IC structure. As shown in FIG. 3, the polymer layer 164 remains on the surface of the PR layer 160 and the sidewall of the opening 162. It is noted that the total thickness of the polymer layer 164 and the remaining PR layer 160 is substantially equal to the thickness of the initial PR layer 160.

Referring to FIGS. 1D and 2, after the patterned BARC 140a is formed, the material layer 120 is etch-patterned using the patterned PR layer 160 and the BARC 140a as a mask (step 210) to form a patterned material layer 120a. In an embodiment, the material layer 120 is a dielectric layer, and the pattern transferred form the patterned PR layer 160 to the dielectric layer is a via hole pattern or a contact hole pattern. A dielectric etching process usually includes a main etching step and an over-etching step.

The main etching step has a higher etching rate to the dielectric layer, and forms less polymer so that the anisotropic etching effect is stronger and the sidewall angle of the via hole is closer to 90°. Meanwhile, in the case of a via hole or a contact hole, polymer is prevented from depositing in a deeper hole so that issues like slow etching, abnormal profile or etching stop can be avoided. Nevertheless, the PR layer 160 and the polymer layer 164 are consumed in the main etching step.

In a main etching step of a dielectric layer according to an embodiment, CF₄ and CHF₃ are introduced in flow rates of 100-200 sccm and 40-160 sccm respectively, the pressure is set at 50-150 mTorr, the top-electrode power is set at 400-600 W, the bottom-electrode power is set at 400-600 W, and the DC bias is adjusted to a value between −600V and −400V.

After the dielectric layer is etched in the main etching condition for a period, over-etching is conducted, which has a lower etching rate to the dielectric layer and a lower anisotropy than the main etching but has a higher selectivity to the dielectric layer for clearing the remaining dielectric layer. In another embodiment, the over-etching is continued until the etching stop layer (not shown) is exposed. The over-etching also consumes the PR layer 160 and the PR layer 164 on sidewall of the opening.

In a dielectric over-etching step according to an embodiment, C₄F₈, Ar and N₂ are introduced in flow rates of 3-12 sccm, 250-350 sccm and 60-240 sccm respectively, the pressure is set at 20-80 mTorr, the top-electrode power is set at 400-1200 W, the bottom-electrode power is set at 1000-1600 W, and the DC bias is adjusted to 0V.

As compared with conventional patterning methods where the patterned PR layer is consumed by ⅓ to ½ of its initial thickness or 800 to 1000 angstroms, the loss of the patterned PR layer 160 is very small, which indicates that most of the PR layer 160 is retained and the consumption of the same can be ignored. In an embodiment where the photoresist treatment is performed with CF₄, CHF₃ and C₄F₈ and the flow rate of CF₄ is lower than 50% of the sum of the respective flow rates of CF₄, CHF₃ and C₄F₈ to form a polymer and Ar and H₂ are used as plasma etching gases to remove the exposed BARC and modify the polymer, the patterned photoresist layer 160 is consumed by merely 150 angstroms. It is clear that the plasma-modified polymer formed in such an embodiment effectively reduces the loss of the patterned photoresist layer.

In this invention, since fluorocarbon-containing plasma is utilized to treat the patterned PR and form polymer thereon, the ant-resistance of the PR layer is enhanced. Moreover, since plasma containing Ar and H₂ but no fluorocarbon species or oxygen-containing species to have higher etching selectivity is used to etch the BARC, the BARC can be patterned without consuming PR and polymer so that PR consumption in one or more etching steps using the PR layer as a mask is reduced. Consequently, the striation and profile deformation can be inhibited allowing accurate pattern transfer, and the PR shrinkage can be controlled to control the after-etching CD so that short between neighboring contacts is prevented in certain cases and the IC design is more flexible. In addition, this invention not only allows reduction in PR thickness in IC fabrication to reduce the cost, but also can be applied to advanced processes requiring thin PR layer or even be used to replacing high-cost patterning methods.

This invention has been disclosed above in the preferred embodiments, but is not limited to those. It is known to persons skilled in the art that some modifications and innovations may be made without departing from the spirit and scope of this invention. Hence, the scope of this invention should be defined by the following claims.

What is claimed is:

1. A patterning method, comprising:
forming, on a bottom anti-reflection coating (BARC), a patterned photoresist layer that has therein an opening pattern exposing a portion of the BARC;
using a first plasma-generating gas containing fluorocarbon species to treat the patterned photoresist layer and form a polymer layer on the patterned photoresist layer and on a sidewall of the opening;
using a second plasma-generating gas to etch the exposed portion of the BARC with the patterned photoresist layer as a mask, so as to formed a patterned BARC, wherein the second plasma-generating gas contains Ar and H₂ but no fluorocarbon species or oxygen-containing species.

2. The patterning method of claim 1, wherein the fluorocarbon species is selected from CₐF_{b} and CₓH_{y}F_{z}, wherein a ranges from 1 to 4, b ranges from 4 to 8, x is equal to 1, y ranges from 1 to 3, and z ranges from 1 to 3.

3. The patterning method of claim 1, wherein the fluorocarbon species includes a high F/C-ratio species and a low F/C-ratio species, a F/C ratio of the high F/C-ratio species ranges from 4 to 3, and a F/C ratio of the low F/C-ratio species ranges from 2 to 1.

4. The patterning method of claim 3, wherein a flow rate ratio of the high F/C-ratio species to the low F/C-ratio species ranges from 20:1 to 20:3.

5. The patterning method of claim 3, wherein the high F/C-ratio species includes one or more fluorocarbon compounds.

6. The patterning method of claim 5, wherein the high F/C-ratio species includes CF₄ and CHF₃, the low F/C-ratio species includes C₄F₈, a flow rate ratio of CF₄ to CHF₃ ranges from 2:3 to 3:2, a flow rate ratio of CF₄ to C₄F₈ ranges from 20:1 to 20:3, and a flow rate of CF₄ is lower than 50% of a sum of respective flow rates of the high F/C-ratio species and the low F/C-ratio species.

7. The patterning method of claim 1, wherein a flow rate ratio of Ar to H₂ ranges from 2:3 to 3:2.

8. The patterning method of claim 1, wherein the patterned photoresist layer is treated under a pressure of 30-300 mTorr.

9. The patterning method of claim 1, wherein the patterned photoresist layer is treated with a top-electrode power of 250-1000 W.

10. The patterning method of claim 1, wherein the patterned photoresist layer is treated with a bottom-electrode power of 200-800 W.

11. The patterning method of claim 1, wherein the BARC is etched under a pressure of 4-40 mTorr.

12. The patterning method of claim 1, wherein the BARC is etched with a top-electrode power of 750-3000 W.

13. The patterning method of claim 1, wherein the BARC is etched with a bottom-electrode power of 250-1000 W.

14. The patterning method of claim 1, wherein the BARC is formed on a material layer, further comprising etching the material layer with the patterned photoresist layer as a mask after the patterned BARC is formed.

15. The patterning method of claim 14, wherein the material layer comprises a dielectric layer and the opening pattern comprises a via hole pattern or a contact hole pattern.

16. A patterning method, applied to a bottom anti-reflection coating (BARC) that has thereon a patterned photoresist layer that has therein an opening pattern exposing a portion of the BARC, and comprising:
using a plasma-generating gas to etch the exposed portion of the BARC with the patterned photoresist layer as a mask, wherein the plasma-generating gas contains Ar and H₂ but no fluorocarbon species or oxygen-containing species.

17. The patterning method of claim 16, wherein a flow rate ratio of Ar to H₂ ranges from 2:3 to 3:2.

18. The patterning method of claim 16, wherein the BARC is etched under a pressure of 4-40 mTorr.

19. The patterning method of claim 16, wherein the BARC is etched with a top-electrode power of 750-3000 W.

20. The patterning method of claim 16, wherein the BARC is etched with a bottom-electrode power of 250-1000 W.
